(19) United States
(12) Patent Application Publication
(10) Pub. No.: US 2015/0355753 A1
(43) Pub. Date: Dec. 10, 2015

(54) CONTROL DEVICE HAVING CAPACITIVE DETECTION

(71) Applicant: DELPHI TECHNOLOGIES, INC., TROY, MI (US)

(72) Inventors: CHRISTOPHE MICHEL, SOULTZ SOUS FORETS (FR); YANNICK MOLARD, HERSBACH (FR)

(21) Appl. No.: 14/761,820

(22) PCT Filed: Jan. 16, 2014
(86) PCT No.: PCT/EP2014/050805

§ 371 Date: Jul. 17, 2015

(30) Foreign Application Priority Data
Jan. 17, 2013 (FR) 1350396

(51) Int. Cl. G06F 3/044

(52) U.S. Cl. CPC G06F 3/044

(57) ABSTRACT

An approach detection device having capacitive detection comprises an electronic board provided with an encoder for detecting displacements which is tied to a knob. The encoder is fixed on the electronic board by a metallic casing comprising a capacitive detector connected to an electrode. The casing is electrically connected to the capacitive detector so the electrode can be used for capacitively detecting an approach to the knob.

### CROSS-REFERENCE TO RELATED APPLICATION

This application claims the benefit under 35 U.S.C. §371 of published PCT Patent Application Number PCT/EP 2014/050805, filed Jan. 16, 2014, claiming priority to French patent application number FR1350396 filed on Jan. 17, 2013, and published as WO2014/111470 on Jul. 24, 2014, the entire contents of which is hereby incorporated by reference herein.

### TECHNICAL FIELD OF INVENTION

The invention relates to a control device having capacitive detection.

### BACKGROUND OF INVENTION

The multiplicity of control devices and their arrangement in the vicinity one with another has led to some of these devices being provided with a capacitive-approach detector. By causing his hand to approach, a user triggers a signal that he can perceive such as an audible signal, a backlighting, a vibration, or else the unlocking of the device.

Traditionally in order to achieve capacitive approach detection, it is necessary to have a capacitive detector, also sometimes referred to as a capacitive driver, a ground plane, and an electrode, also sometimes referred to as an antenna, in order to detect the variations in capacity created between the electrode and the ground plane. The electrode is conventionally embodied by an add-on part which may be an electric wire, a flexible metallic film glued under a plastic part, an antenna silk-screen printed on the printed circuit or a metallic antenna soldered on the printed circuit or in contact with the latter such as for example a spring.

The conventional solution exhibits the problems that on the one hand the integration of the electrode requires additional space, surface, or volume, which is difficult to make available, and, on the other hand, the general cost of the device is increased by the associated cost of the electrode, and also by the associated costs such as those of the manufacturing operations.

### SUMMARY OF THE INVENTION

The present invention solves the problems mentioned hereinabove by proposing a control device having capacitive detection comprising an electronic board provided with a means for detecting displacements of a manual interface which is directly tied to it and a capacitive detector connected to an electrode. The means is fixed on the board by a metallic casing. The casing is moreover electrically connected to the capacitive detector so as to form the electrode for detecting capacitive approach to the interface.

The casing is provided with mounting brackets soldered to the electronic board for mechanical holding. One of the mounting brackets is moreover electrically connected to the capacitive detector. Moreover, the capacitive detector can advantageously be integrated into a microcontroller of the electronic board. The means for detecting displacements can be a potentiometer, an annular encoder, an axial encoder or an electronic or optical means or a means according to any other technology.

Moreover, the approach to the interface triggers a signal perceptible to a user such as an audible, luminous, or haptic signal such as a vibration. The manipulatable interface can be a rotary knob or buttons, cursors or joysticks of any other sort.

The invention also relates to a control module comprising at least one device embodied according to the above paragraphs. The module can make it possible to control the radio or the air conditioning or be a selector of functions whatever function this be.

### BRIEF DESCRIPTION OF DRAWINGS

An embodiment of the invention is now described by way of the following figures.

FIG. 1 is an overall view of a control module having rotary knobs;

FIG. 2 is a view of the electronic board of the module of FIG. 1;

FIGS. 3, 4 and 5 successively represent a potentiometer, an annular encoder, and an axial encoder, all of which may be fixed by a casing on the electronic board of FIG. 2;

FIGS. 6 and 7 are two alternative representations of connection of the electronic board of FIG. 2.

### DETAILED DESCRIPTION

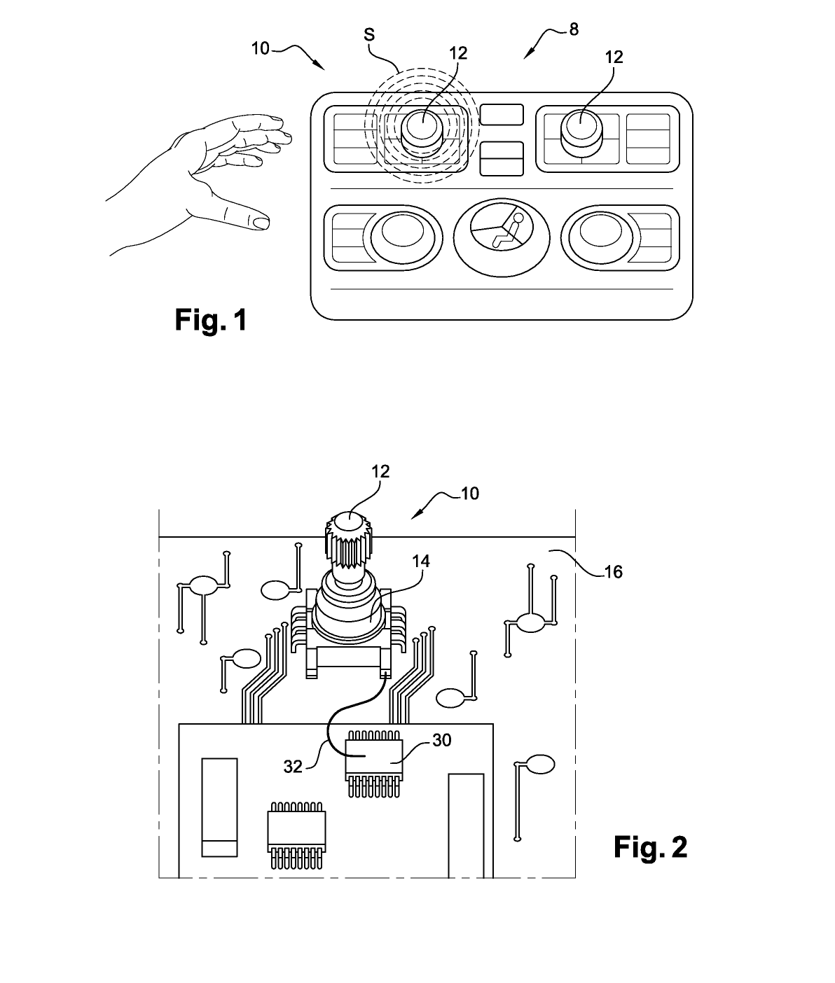

According to FIG. 1 an automobile control module 8 is presented. The module 8 comprises a styling panel provided with two selection knobs 12 in the top portion and control knobs for the air conditioning system in the bottom portion. The module 8 is provided with an approach detection device 10 also, a user approaches the module 8 with their hand and a knob 12 emits a signal S, symbolized in the FIG. 1 by the concentric circles entered around the knob 12. The signal S is emitted before the hand is in contact with the knob 12. The signal can be of any nature for example audible, a “beep”, a chime, or the noise of a vibration, it may also be luminous such as the backlighting of a logotype drawn on the knob 12.

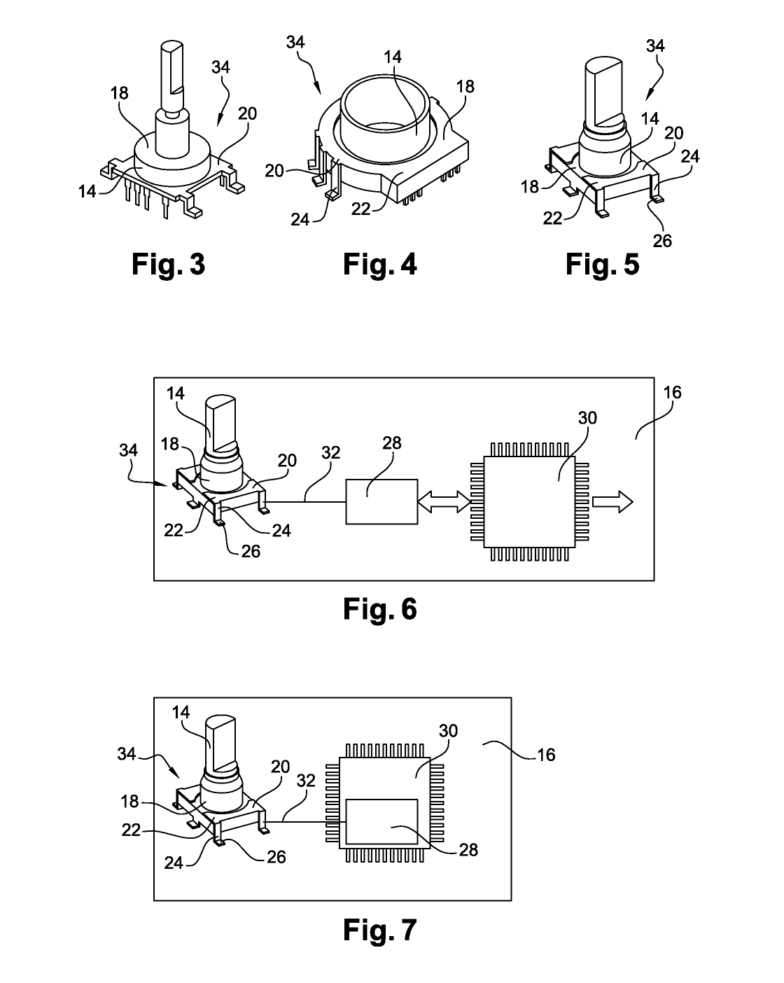

According to FIG. 2, the detection device 10 comprises the rotary knob 12 which drives an encoder 14 placed just behind the styling panel. It may be any means making it possible to detect the displacements of the knob 12, for example a mechanical encoder 14 such as a potentiometer, an annular encoder or an axial encoder, respectively presented in FIGS. 3, 4 and 5. It may also be an electronic or optical means or a means according to any technology. The encoder 14 is electrically and mechanically connected to an electronic board 16. From an electrical point of view, the encoder 14 transforms an electrical input current as a function of the rotations of the knob 12 and, from the mechanical point of view, the encoder 14 is arranged in a housing 18 itself fixed to the electronic board 16 by means of a metallic casing 20. The casing 20 comprises a main portion 22 provided with a central orifice through which the mechanical extension for linkage between the encoder 14 and the knob 12 passes.

The casing 20 is arranged on the housing 18, parallel to the electronic board 16 and, at its periphery, the main portion 22 is provided with mounting brackets 24 bent at right angles relative to the main portion 22 and extending along the sides of the housing 18 as far as a distal end 26 soldered to the electronic board 16. Thus made, the encoder 14 is held in place on the electronic board, the housing 18 being imprisoned between the main portion 22, the mounting brackets 24, and the electronic board 16.

According to FIGS. 6 and 7, the electronic board 16 is also provided with an electronic circuit for capacitive detection 28 electrically connected on the one hand to the main microcontroller 30 of the electronic board 16 and on the other hand to one of the mounting brackets 24 of the encoder 14. The electronic board 16 is provided with a specific track 32 to ensure this linkage. Thus connected, the metallic casing 20 becomes the capacitive detection electrode 34 tied to the detector 14. The casing 20 therefore has a mechanical role, the fixing of the encoder 14 on the electronic board 16, and an electronic role, capacitive detection electrode 34. The electrode 34 charts the variations of capacitive field between the casing 20 and the ground plane of the electronic board 16, said variations being created by the approach of the hand—FIG. 1.

Moreover, as shown diagrammatically in FIG. 7, there exist microcontrollers 30 integrating an electronic circuit for capacitive detection 28. Thus, an approach detection device can be created without requiring any additional component.

1. An approach detection device having capacitive detection, said device comprising:
an electronic board provided with an encoder for detecting displacements of a knob which is directly attached to the encoder; and
a capacitive detector connected to an electrode,
the encoder being fixed on the electronic board by a metallic casing, wherein the casing is electrically connected to the capacitive detector so the electrode can be used for capacitively detecting an approach to the knob, and said knob is a rotary knob.

2. The device as claimed in claim 1, in which the casing is provided with mounting brackets soldered to the electronic board for mechanical holding, at least one of the mounting brackets being electrically connected to the capacitive detector.

3. The device as claimed in claim 1, in which the capacitive detector is integrated into a microcontroller of the electronic board.

4. The device as claimed in claim 1, in which the encoder for detecting displacements is a potentiometer.

5. The device as claimed in claim 1, in which the encoder for detecting displacements is an annular encoder.

6. The device as claimed in claim 1, in which the encoder for detecting displacements is an axial encoder.

7. The device as claimed in claim 1, in which the encoder for detecting displacements is an electronic or optical means.

8. The device as claimed in claim 1, in which the detection of the approach to the knob triggers a signal (S) perceptible to a user such as an audible, luminous or haptic signal.

9. A control module comprising at least one device as claimed in claim 1.
